(19) United States
(12) Patent Application Publication
(10) Pub. No.: US 2011/0148056 A1
(43) Pub. Date: Jun. 23, 2011

(54) Kart Kovey

(76) Inventor: Jennie Niernberger, Tracy, CA (US)

(21) Appl. No.: 12/610,538

(22) Filed: Dec. 17, 2009

(51) Int. Cl. B62B 5/00

(52) U.S. Cl. 280/33.992

(57) ABSTRACT

1. The cover (Kart Kovey) is easy to install or remove from any store shopping cart handle. Velcro pads attach the Kart Kovey around the handle (FIGS. 2 and 5). The under surface may be sprayed with a disinfectant to prevent the Kart Kovey from becoming a carrier of germs.

2. The cover can be easily removed from the shopping cart handle by pulling up on the folded side. See FIG. 2 REFERENCE 10.

3. The cover when removed from the shopping cart handle can be inserted into its plastic storage bag. The bag prevents germs from being spread while not in use by the user (FIG. 3).

4. The Kart Kovey is washable in soapy water to kill germs

5. The protective bag can be washed in soapy water to remove germs.

6. The Kart Kovey can be used on other similar handles to achieve isolation from germs left from previous users. Similar application use is for stroller handless, walkers and hospital carts.

7. The Kart Kovey is compact: can be folded and inserted into its plastic storage bag and can be inserted into a handbag (FIG. 3).

### BACKGROUND

This invention (cover for a shopping cart handle) was developed to prevent the spread of germs through contact. It is for used on public conveyances, specifically shopping cart handles in stores. Store shopping cart handles provide contact surfaces where germs may be transferred from user to user as the cart is reused. This invention is a reusable shopping cart handle cover specifically designed to prevent the spread of germs through contact during reuse of shopping carts.

This store shopping cart handle cover (Kart Kovey) is a portable personal item carried by an individual. It is inserted over the store shopping cart handle when the individual owner selects a store shopping cart for use. Once inserted over the store shopping cart handle, the individuals' hands are isolated from direct contact of the store shopping cart handle. Thus germs transferred to the store shopping cart handle by previous users are isolated from the current user.

Germ control preventative measures are achieved by spraying the underside surface of the cover with a common household disinfectant (such as Lysol) prior to use. This can be done in the user's home by opening the store shopping handle cover up, laying the cover on a flat surface with the inside facing up (FIG. 4), then spraying with a disinfectant (such as Lysol). The store shopping handle cart cover can be then folded with the inside surface facing in and then inserted into its carrying bag (FIG. 3).

When the user arrives at the store shopping he takes the cover out of the bag and attaches to the shopping cart handle (FIGS. 2 and 5). When done with the shopping cart the cover is removed with a single tug at the seam (FIG. 2 REF 10). Design allows for quick and easy removal from the shopping cart handle. The cover is then inserted into its carrying bag. To further minimize the spread of germs, when the user returns home, the shopping cart handle cover and bag can be washed in a washing machine with detergent. After being washed and dried, the inside surface can be sprayed with disinfectant once again, thus the Kart Kovey is reusable for as many times as the user should choose to use it.

At this time there are no current commercial store shopping cart handle covers that have the advantages of this invention.

### SUMMARY

This invention, a store shopping cart handle cover (Kart Kovey) was developed because there are no reusable products available for use by individuals to limit exposure to germs spread via shopping cart handles.

### DRAWINGS

FIG. 1: shopping cart handle (without cover)

FIG. 2: shopping cart handle with cover (Kart Kovey)

FIG. 3: storage bag and cover

FIG. 4: cover open on flat surface inside facing up

FIG. 5: FIG. 5 Kart Kovey folded (ready to slip over cart handle)

### DETAILED DESCRIPTION

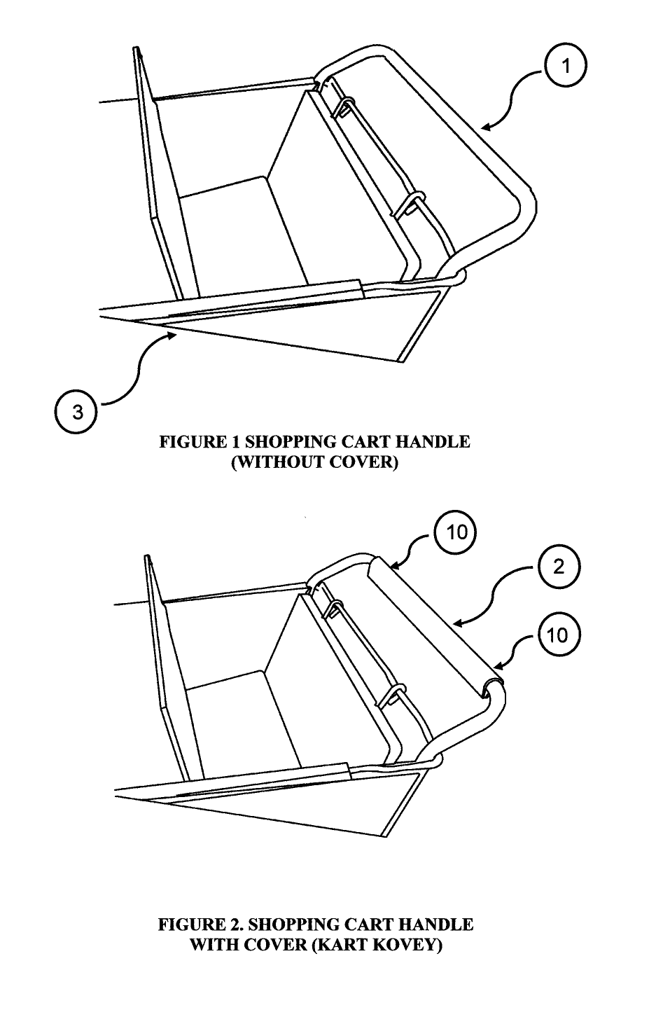

FIG. 1 is a picture of a common shopping cart. The handle is shown and text indicates where the individual places his hands.

FIG. 2 shows the shopping cart handle cover (Kart Kovey) applied to the handle shown in FIG. 1. The cover is folded over the handle and secured into place with the Velcro strips.

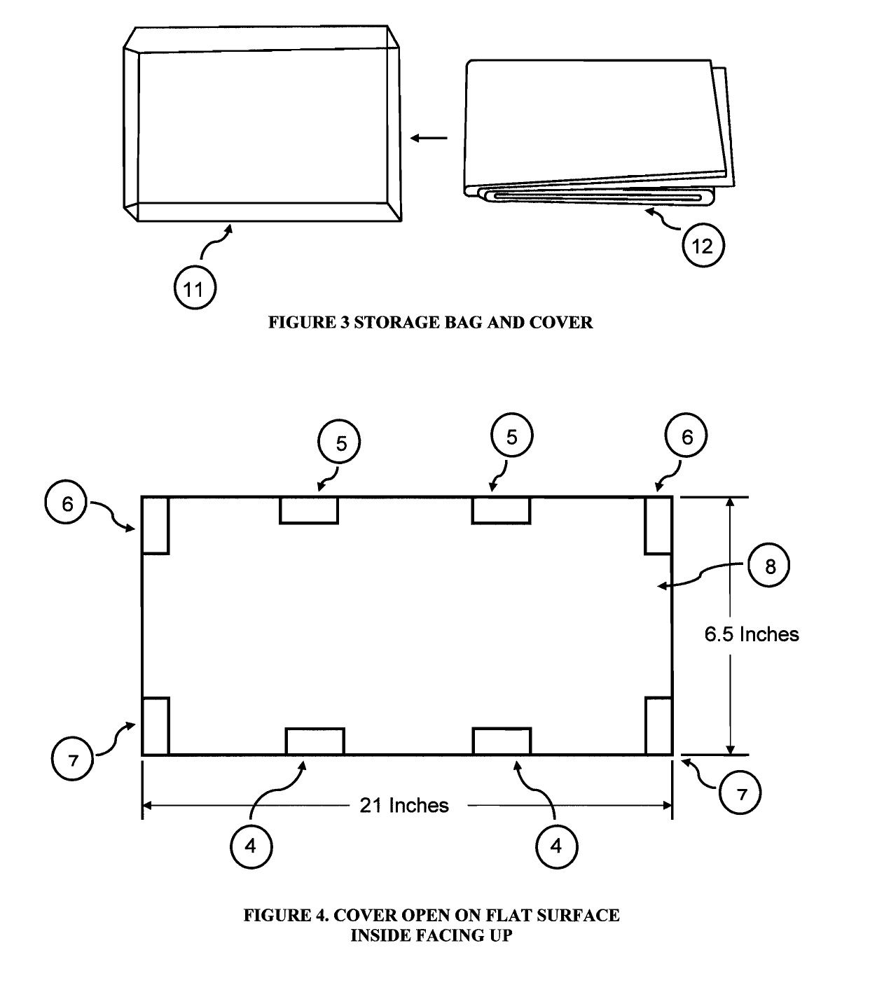

FIG. 3 show the cover (Kart Kovey) folded and inserted into its storage bag. FIG. 4 shows the dimensions of the cover, 21 inches long and 6.5 inches wide. The drawing also shows the how the Velcro tabs are spaced, evenly along each side of the inside of the Kart Kovey.

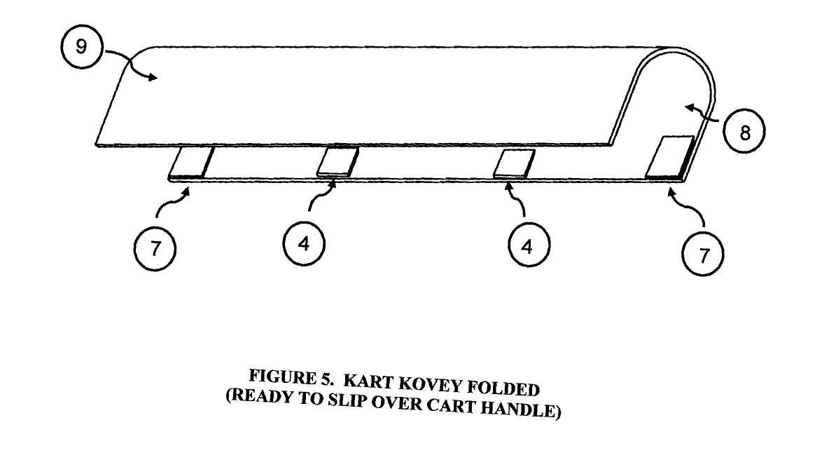

FIG. 5 shows how the cover is folded prior to application to the shopping cart handle. The Velcro tabs are facing inwards and aligned relative to its mate.

Materials

The materials that make up the Kart Kovey consists of machine washable quilted cloth for the body (68% cotton/32% polyester) of the cover and Velcro pads for the attach points. As an assembly the Kart covey is hand or machine washable. The storage bag consists of transparent plastic non-reactive to soap and water.

### REFERENCE NUMERALS

1. Shopping Cart Handle

2. Shopping Cart Handle Covered With Shopping Cart Handle Cover

3. Shopping Cart

4. Velcro—1.5×0.75 Inches, Female

5. Velcro—1.5×0.75 Inches, Male

6. Velcro—2×0.75 Inches, Male

7. Velcro—2×0.75 Inches, Female

8. Cover, Inside Surface

9. Cover, Outside Surface

10. Pull at These Points for Removal

11. Plastic Bag

12. Folded Cover

### OPERATION

In operation the shopping cart handle cover (Kart Kovey) is an application of the physical cover itself plus the application of accepted principles of sanitation. It is common knowledge that germs can be transferred between individuals on common contact surfaces. Shopping cart handles provide a surface that is exposed to an unpredictable selection of elements, including human and animal waste by-products. In operation, the shopping cart handle cover (Kart Kovey) isolates the user from the handle itself. If the user follows the recommended practices of using a disinfectant on the covers' inner surface, carrying the cover in its storage bag when not in use and washing the cover after use; individual exposure to germs transmitted via the shopping cart handle can be minimized.

1. A store shopping cart handle cover, comprising:
An inner surface which will overlie the shopping cart handle when said handle is exposed for use by an individual. Velcro strips that are located on the inside surface, these are located so that the cover does not slide sideways during use. They are also located such that the cover can be easily removed.
An outer surface which will provide a contact surface for the individual user such that a comfortable grip is possible by the user
An internal padding layer provides a tactile feel by the grip of the user such that the shopping cart can be guided easily.
The three layers are quilted together to make the layers resistant to slippage relative to each layer.
Whereby (a) transfer of germs between individuals by direct surface contact with shopping cart handles is minimized by use of the reusable shopping cart handle cover. (b) Prevention of germ transfer by the cover is minimized when the inner surface of the cover is sprayed with disinfectant; this minimizes the transfer of germs between the shopping cart handle and the shopping cart handle cover. (c) Germ transfer is minimized by use of a plastic carrier. (d) The shopping cart handle cover and carrier bag is washable and reusable.
